(19) United States
(12) Patent Application Publication
(10) Pub. No.: US 2026/0164474 A1
(43) Pub. Date: Jun. 11, 2026

(54) POWER PRIORITIZATION OF PRACH AND UE-BASED TIMING ADVANCE ACQUISITION FOR CANDIDATE CELLS IN WIRELESS COMMUNICATION

(71) Applicant: APPLE INC., Cupertino, CA (US)

(72) Inventors: Hong HE, San Jose, CA (US); Ankit BHAMRI, Bad Nauheim (DE); Chunxuan YE, San Diego, CA (US); Dan WU, Beijing (CN); Dawei ZHANG, Saratoga, CA (US); Wei ZENG, Saratoga, CA (US); Weidong YANG, San Diego, CA (US)

(21) Appl. No.: 18/709,361

(22) PCT Filed: May 11, 2023
(86) PCT No.: PCT/CN2023/093482

§ 371 Date: May 10, 2024

(51) Int. Cl. H04W 74/0838; H04W 72/21

(52) U.S. Cl. CPC H04W 74/0838; H04W 72/21

(57) ABSTRACT

This application describes processes and systems for configuration of a user equipment (UE) based timing advance (TA) acquisition and power prioritization of the physical random access channel (PRACH) in wireless communication networks.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

This application describes processes and systems for configuration of a user equipment (UE) based timing advance (TA) acquisition and power prioritization of the physical random access channel (PRACH) in wireless communication networks. Communication networks, such as fifth generation (5G) new radio (NR) networks, are configured for mobility robustness when a UE is moving within the network. The UE may be executing one or more applications or using one or more services that rely on low-latency and high reliability performance (e.g., URLLC) in the network.

This specification describes mechanisms and procedures related to L1/L2 based inter-cell mobility (LTM) for mobility latency reduction. Specifically, this specification describes timing advance (TA) management, such when multiple TAs are configured.

This specification describes how the UE operations in a power-limited scenario for LTM. For example, this specification describes a process for how a UE is configured to split transmission power for a PDCCH-order PRACH transmission on a candidate cell and for an UL transmission on a serving cell

This specification describes processes for enabling UE-based TA acquisition. The specification describes processes for a UE-based TA measurement in which the UE is configured to determine the TA based on a receive (Rx) timing difference between a current serving cell and a candidate cell and based on the TA value for the current serving cell.

In accordance with one aspect of the present disclosure, an example process includes receiving, at a user equipment (UE), configuration data from a wireless communication network, the configuration data specifying one or more prioritization rules for the UE to transmit to a serving cell or a candidate cell in the wireless communication network, the one or more prioritization rules specifying transmission priority for a first transmission comprising a physical data or control channel and a second transmission comprising a physical random access channel (PRACH) when the UE is scheduled to perform the first transmission and the second transmission and the first transmission and the second transmission overlap in time. The process includes transmitting, by the UE in accordance with the one or more prioritization rules, the first transmission, the second transmission or both the first transmission and the second transmission.

In some implementations, the configuration data are transmitted from the communication network as part of a system information block (SIB). In some implementations, the configuration data are transmitted from the communication network as part of radio resource control (RRC) signaling. In some implementations, the one or more priority rules for the UE are for a L1/L2 triggered mobility (LTM) scenario for the UE.

In some implementations, the physical data or control channel comprises a physical uplink shared channel (PUSCH). In some implementations, the physical data or control channel comprises a physical uplink control channel (PUCCH). In some implementations, the one or more prioritization rules specify that, for a single frequency, the PRACH transmission to the candidate non-serving cell is prioritized over the overlapping PUSCH transmission to the serving cell on a same frequency.

In some implementations, the one or more prioritization rules specify that a PRACH transmission on a primary cell has a first priority, a contention-based random access (CFRA) PRACH transmission to one or more candidate non-serving cells has a second priority, a PUCCH or a PUSCH transmission on a serving cell has a third priority, an aperiodic sounding reference signal (SRS) on a serving cell has a fourth priority, a PRACH transmission on a secondary on a serving cell has a fifth priority, and a periodic or semi-persistent SRS on a serving cell has a sixth priority. In some implementations, the first transmission overlaps with the second transmission, and wherein the serving cell is in a first frequency, and wherein the candidate cell is within a second frequency. In some implementations, the one or more prioritization rules specify that the second transmission using the PRACH is prioritized over the first transmission using a PUSCH when they are overlapped in time domain.

In some implementations, the UE has at least two CFRA PRACH transmissions on two candidate non-serving cells overlap in time, and wherein the one or more prioritization rules specify a prioritization for the at least two overlapping CFRA PRACH transmissions based on a respective cell identifier of a respective candidate cell that is associated with each respective CRFA PRACH transmission of the at least two overlapping CRFA PRACH transmissions.

In some implementations, the first transmission overlaps with the second transmission in time and frequency, wherein the UE is not capable of simultaneous uplink transmissions over multiple panels (STxMP), and wherein the one or more prioritization rules specify that the second transmission comprising the PRACH transmission has a higher priority than the first transmission, the first transmission comprising a PUSCH transmission.

In accordance with one aspect of the present disclosure, an example process includes receiving, at a user equipment (UE), configuration data specifying a timing advance (TA) acquisition process for the UE in a L1/L2 triggered mobility (LTM) scenario. The process includes transmitting uplink (UL) data to a target cell, the transmitting being based on a TA value that is determined by the UE based on the TA acquisition process specified by the configuration data.

In some implementations, the configuration data is received at the UE based on dedicated radio resource control (RRC) signaling. In some implementations, the RRC signaling comprises an indicator that indicates an on state for the UE or an off state for the UE where the ‘on’ state is used to enable the TA acquisition process for all the candidate non-serving cells and the ‘off’ state is used to disable the TA acquisition process for all the candidate non-serving cells. In some implementations, the RRC signaling comprises an indicator for each candidate cell of the set of candidate cells that indicates an on state or an off state for the UE-based TA acquisition process, wherein the target cell of LTM operation is a candidate cell of the set of candidate cells.

In some implementations, the configuration data is received at the UE based on a medium access control (MAC) control element (CE), the MAC CE activating a set of transmission configuration indicator (TCI) states before a cell-switching operation for a candidate cell, wherein a separate field in the MAC CE enables the TA acquisition process for the candidate cell.

In some implementations, the UE is configured to derive a TA value for a candidate cell based on a TA value of a serving cell and a downlink reception timing difference (RTD) between the serving cell and the candidate cell responsive to the MAC-CE activating the TCI state(s) for the candidate cell.

In some implementations, a cell-switch command (CSC) triggering cell switch to a candidate non-serving cell enables the TA acquisition process for the candidate non-serving cell.

In some implementations, a medium access control (MAC) control element (CE) is configured to activate or deactivate the TA acquisition process based on a receive signal receive power (RSRP) associated with different candidate non-serving cells of the UE. In some implementations, the MAC CE comprises a plurality of index fields, each index field associated with a candidate cell index, and wherein a value of a given index field Ci indicates an activation or deactivation of a candidate cell associated with the candidate index of the given index field Ci. In some implementations, the MAC CE has a fixed size.

In accordance with one aspect of the present disclosure, an example process includes receiving, receiving, at a user equipment (UE), configuration data specifying a trigger condition for the UE to update a timing advance (TA) value for a candidate cell for a L1/L2 triggered mobility (LTM) operation. The process includes updating, by the UE and based on the configuration data, the TA value for the candidate cell.

In some implementations, the configuration data is transmitted to the UE based on radio resource control (RRC) signaling, wherein the configuration data specifies a TA update timer, and wherein the UE is configured to update the TA value for the candidate cell when the TA update timer expires.

In some implementations, the set of timing accuracy requirements is predefined in a specification, and wherein the UE updates the TA value to meet the predefined timing accuracy requirement that is independent of receiving the configuration data.

In some implementations, the configuration data is transmitted to the UE based on downlink control information (DCI) format. In some implementations, the DCI format comprises a plurality of fields for a common UE, wherein each field of the plurality specifies a TA update value that indicate whether the common UE is triggered to update the TA value for a corresponding candidate cell. In some implementations, the field index of TA update value for a corresponding candidate non-serving cell is configured based on RRC signaling. In some implementations, the TA update value for each corresponding candidate cell is associated based on an order of the fields in the DCI format, wherein TA values of the plurality of fields are assigned to respective candidate cells based on the respective cell indexes of the candidate cells. In some implementations, the DCI format comprises a plurality of fields, wherein each field of the plurality specifies, for a respective different UE, a corresponding candidate cell index.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2 illustrates an example of a network in which an example UE performs PDCCH-order physical random access (PRACH) transmission.

FIG. 3 illustrates an example of a network in which an example UE performs PDCCH-order PRACH transmission.

FIG. 4A illustrates an example of a UE-based TA acquisition procedure for a UE based on radio resource control (RRC) signaling.

FIG. 4B illustrates an example of a UE-based TA acquisition procedure for a UE based on a MAC CE.

FIG. 4C illustrates an example of a UE-based TA acquisition procedure for a UE based on a cell-switch command (CSC).

FIG. 5A illustrates an example of a DCI format configured to trigger the TA update procedure.

FIG. 5B illustrates an example of a DCI format configured to trigger the TA update procedure.

FIG. 6 illustrates an example of a MAC CE configured for activating or deactivating a subset of candidate cells for a UE-based TA acquisition procedure.

FIG. 7 illustrates a flowchart of an example method, according to some implementations.

FIG. 8 illustrates a flowchart of an example method, according to some implementations.

FIG. 9 illustrates a flowchart of an example method, according to some implementations.

FIG. 10 illustrates an example user equipment (UE), according to some implementations.

FIG. 11 illustrates an example access node, according to some implementations.

### DETAILED DESCRIPTION

This application describes processes and systems for configuration of a user equipment (UE) based timing advance (TA) acquisition and power prioritization of the physical random access channel (PRACH) in wireless communication networks. Communication networks, such as fifth generation (5G) new radio (NR) networks, are configured for mobility robustness when a UE is moving within the network. The UE may be executing one or more applications or using one or more services that rely on low-latency and high reliability performance (e.g., URLLC) in the network.

Generally, the PRACH is used to carry a random access preamble from a UE to a next generation node (gNB), such as a base station. The base station uses the PRACH transmission, in addition to other parameters, to adjust uplink timings of the UE. In some implementations, Zadoff chu sequences are used to generate random access preambles. In contract to LTE networks, the 5G NR random access preamble configuration supports two different sequence lengths with various format configurations, used in wide deployment scenarios. For example, an 839 long sequence uses four preamble formats. The preamble formats are for large cell deployment in FR1 (Sub-6 GHz range), and use subcarrier spacing of 1.25 kilohertz (KHz) or 5 KHz. The 139 short sequence uses nine preamble formats. These formats are designed for small cell deployment including indoor coverage. These preamble formats are used for both FR1 (sub-6 GHz) and FR2 millimeter wave (mmwave) ranges. FR1 supports 15 or 30 KHz subcarrier spacing, and FR2 supports 60 or 120 KHz subcarrier spacing.

Generally, PRACH uses a same FFT as is used for data. The OFDM baseband signal generation for PRACH is defined in 3GPP TS 38.211 section 5.3.2. For beam establishment, different SS block time indices are associated with different RACH time/frequency occasions. SIB1 provides the “number of SS-block time indices per RACH time/frequency occasion.” SSB time indices are associated with RACH occasions, first in frequency, then in time within a slot, and last in time between slots. For UE initial access, the reference signals used for beam management are the primary synchronization signal (PSS), the secondary synchronization signal (SSS), and the physical broadcast channel (PBCH) demodulation reference signal (DM-RS). The PBCH DMRS can include the synchronization signal block (SSB) for the idle mode. The PBCH DMRS can include a channel state information reference signal (CSI-RS) for downlink (DL) transmissions and the sounding reference signal (SRS) for uplink (UL) transmissions in the connected mode.

This specification describes mechanisms and procedures related to L1/L2 based inter-cell mobility (LTM) for mobility latency reduction. Specifically, this specification describes timing advance (TA) management, such when multiple TAs are configured. A physical downlink control channel (PDCCH)-order PRACH transmission on a candidate cell can be overlapped with an uplink transmission on a serving cell. This specification describes how to prioritize an overlapped transmission for a UE that is incapable of simultaneous transmissions across multiple panels (STxMP). In this case, instead of intrafrequency transmissions, multiple panels can be used for parallel transmissions by the UE, such that UL data transmission and PRACH are scheduled to occur in parallel. This specification describes the prioritization between the overlapping transmissions within a frequency band.

This specification describes how the UE operations in a power-limited scenario for LTM. For example, this specification describes a process for how a UE is configured to split transmission power for a PDCCH-order PRACH transmission on a candidate cell and for an UL transmission on a serving cell. The UE determines a transmission priority between the parallel PDCCH and UL transmission for the serving cell wherein the UE does not exceed the transmission power specified by the UE power class.

This specification describes processes for enabling UE-based TA acquisition. The specification describes processes for a UE-based TA measurement in which the UE is configured to determine the TA based on a receive (Rx) timing difference between a current serving cell and a candidate cell and based on the TA value for the current serving cell. In the LTM context, the UE is moving, and the UE updates the TA configuration based on the changes to the measured timing difference between a current serving cell and a candidate cell. A corresponding UE capability is to be introduced to support UE-based TA measurement.

The UE, to update the determined TA configurations, the UE consumes memory, bandwidth, and power. The UE updates the supported number of cells for which the UE is able to update TA configurations based on memory, bandwidth and power constraints of the UE. The UE is configured to report that the UE supports UE-based TA acquisition and also the configuration(s) of the UE-based TA measurement that are supported. Specifically, this specification describes how to enable or configure the UE-based TA acquisition for candidate cells in LTM operation. This specification describes how to trigger the UE to perform the TA update for candidate cell for the UE-based TA acquisition. This specification describes how to efficiently manage the candidate cells to enable UE-based TA acquisition when the UE may only support a limited number of cells for such a procedure. The UE-based TA acquisition processes described herein can enable removal of uplink synchronization procedures in legacy handover steps for LTM.

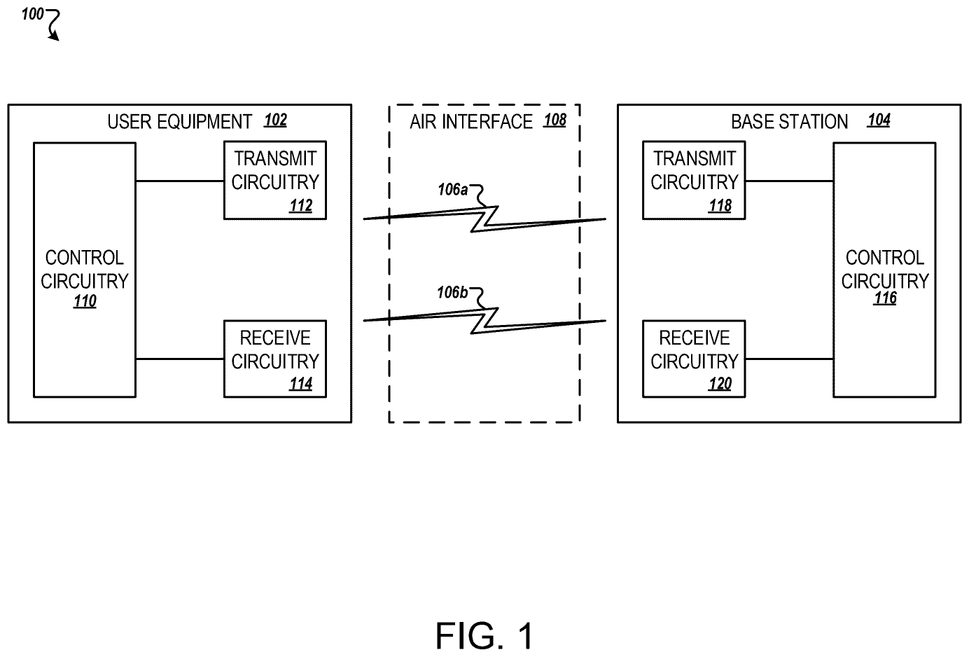

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE.

The transmit circuitry 112 can perform various operations described in this specification. The transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

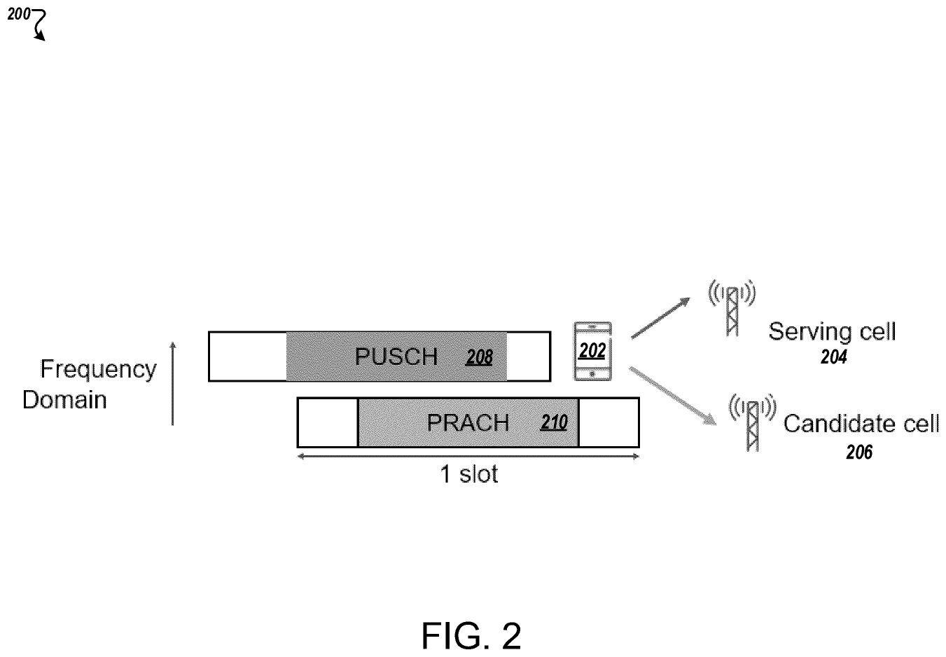

FIG. 2 illustrates an example of a network 200 in which an example UE performs PDCCH-order PRACH transmission. The example UE 202 can include the UE 102 previously described in relation to FIG. 1. The base station of the serving cell 204 and/or the candidate cell 206 can each include the base station 104 previously described in relation to FIG. 1. The scenario shown in FIG. 2 shows that the serving cell 204 and the candidate cell 206 are receiving transmissions using different frequency layers in the frequency domain. The UE 202 transmits a PUSCH transmission 208 and the PRACH transmission 210 at the same time, but at different frequency layers. The physical uplink shared channel (PUSCH) is used to carry the user data and optionally the Uplink Control Information (UCI). For example, the PUSCH transmission 208 by the UE 202 to the serving cell 204 uses a first frequency layer, and the PRACH transmission 210 by the UE 202 uses a second, different frequency layer. In this example, the PUSCH and the PRACH are being transmitted in parallel (e.g., over a slot) in a high mobility operation scenario. In this example, the UE 202 prioritizes the PRACH transmission on the candidate cell 206 over overlapping PUSCH transmissions on the serving cell 204 to minimize the TA acquisition latency for LTM. The UE 202 performs power scaling in this context as subsequently described.

The UE 202 is configured to determine a priority for the PUSCH transmission or the PRACH transmission in scenarios in which total transmission power for UL transmissions across serving cells and candidate cell(s) exceeds a threshold maximum transmission power of the UE. The threshold maximum transmission power can be predefined.

The prioritization of the PUSCH and PRACH is defined as described. In a first example, the priority order is pre-defined (hard-coded) for the UE 202. The pre-defined order ensures that the UE 202 allocates power so that a total UE transmission power does not exceed the threshold maximum transmission power for the UE. In some implementations, the prioritization is pre-defined as follows, in a descending order of priority. A first priority (higher) includes a PRACH on a primary cell (PCell). The second priority is a contention-based random access (CFRA) PRACH on one or more candidate cell(s) for LTM operation. The third priority includes PUCCH and/or PUSCH transmissions. The fourth priority includes aperiodic sounding reference signal (SRS) transmissions. SRS is transmitted at the last symbol of UL slot with full system band area and it is transmitted by a certain interval and that enables a base station (e.g., a gNB) to perform channel quality estimation based on the SRS from the UE. The fifth priority includes PRACH on a secondary cell (SCell). A sixth (lower) priority includes a periodic or semi-persistent SRS transmission. In some implementations, there are more than one CFRA PRACHs overlapping on candidate cells, such as candidate cell 206 and other candidate cells. In this case, the UE 202 prioritizes the CFRA PRACH on a given candidate associated with a smaller candidate cell identifier (ID). FIG. 2 shows a network 200 in which the PRACH transmission 210 for the candidate cell 206 is prioritized over the PUSCH transmission 208 for the serving cell 204.

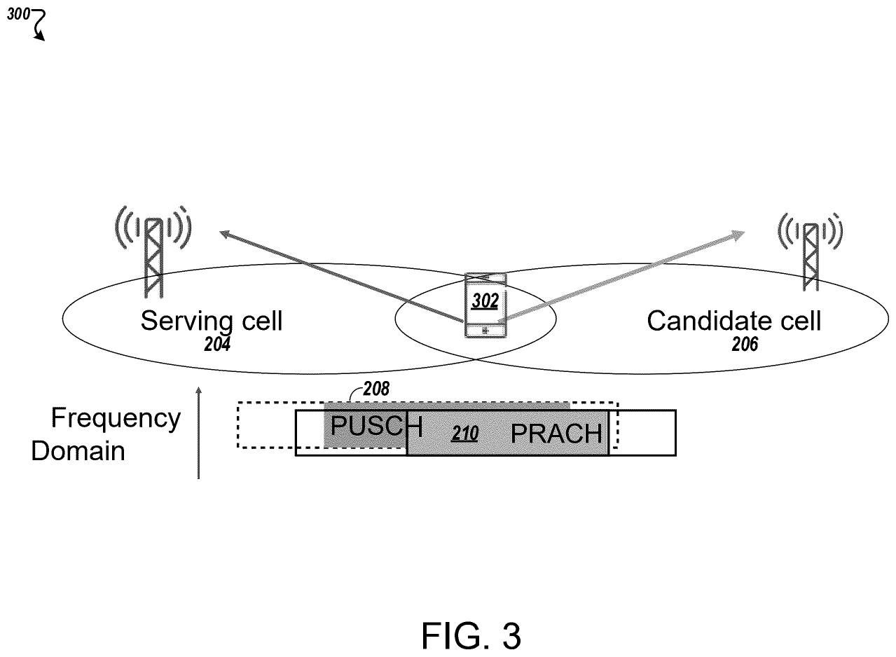

FIG. 3 illustrates an example of a network 300 in which an example UE 202 performs PDCCH-order PRACH transmission. The example UE 302 can include the UE 102 previously described in relation to FIG. 1. The base station of the serving cell 204 and/or the candidate cell 206 can each include the base station 104 previously described in relation to FIG. 1 or FIG. 2. Specifically, FIG. 3 illustrates an example scenario in which a UE 302 has a scheduled PUSCH transmission 208 towards a serving cell 204 and a PRACH transmission toward a candidate cell 206. In this scenario, the UE 302 is unable to perform parallel or simultaneous transmission of the PSUCH transmission 208 and the PRACH transmission 210, such as on different frequency layers. In this example, the UE 302 is configured to prioritize the PRACH 210 transmission tot eh candidate cell 206, as shown in FIG. 3. The UE 302 thus performs prioritization of PRACH 210 on the candidate cell 206 over overlapped PUSCH transmissions 208 on the serving cell 204. The UE 302 drops the overlapped PUSCH symbols due to overlapping with the PRACH transmission 210.

The scenarios in FIGS. 2-3 are examples of a prioritization rules, but one or more other prioritization rules can be pre-defined for the UE 302. The network selects one configuration based on the deployment scenario. The network indicates the selected rules to the UE 302 through one or more mechanisms. For example, the network may signal prioritization rules using a system information block (SIB). In another example, the network signals the configuration to the UE by a UE-dedicated RRC signal to operate L1/L2 triggered mobility (LTM) operation.

In some implementations, the UE, such as UE 302, is not capable of simultaneous uplink transmissions over multiple panels (STxMP). In an example, the UE 302 is configured to prioritize the contention-based random access (CFRA) PRACH towards the candidate cell 206 and at least drop the overlapping part of UL transmissions on a serving cell 204.

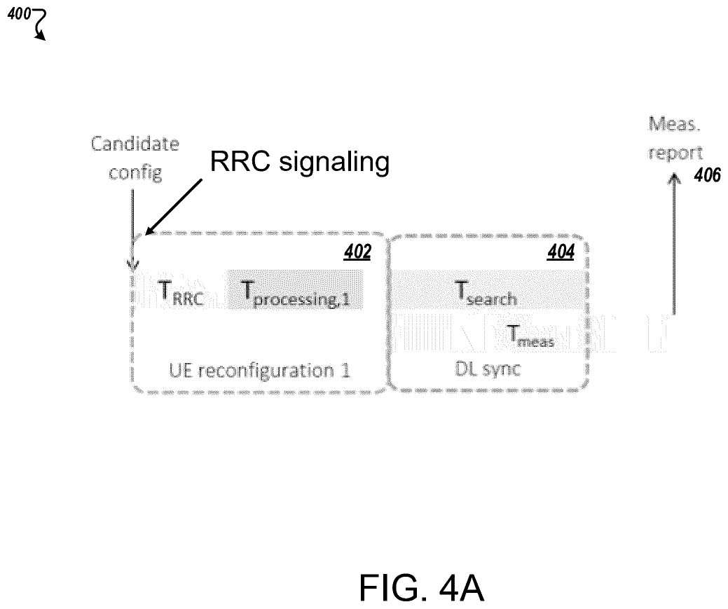

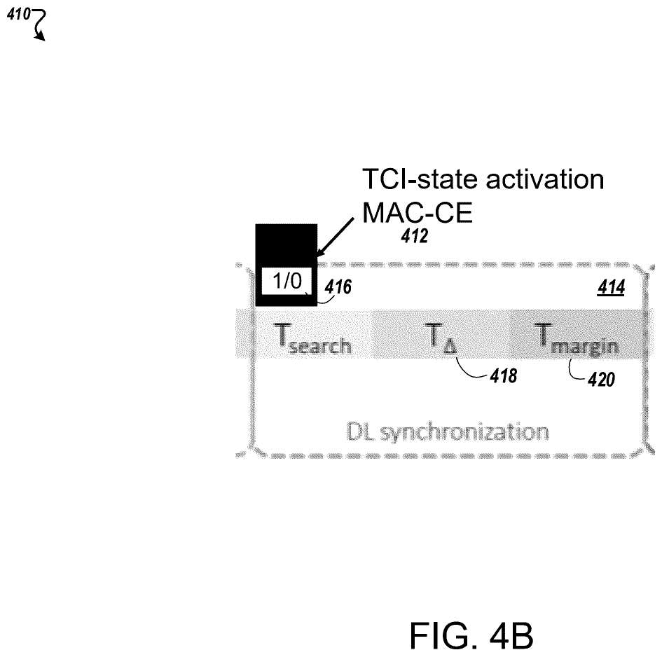

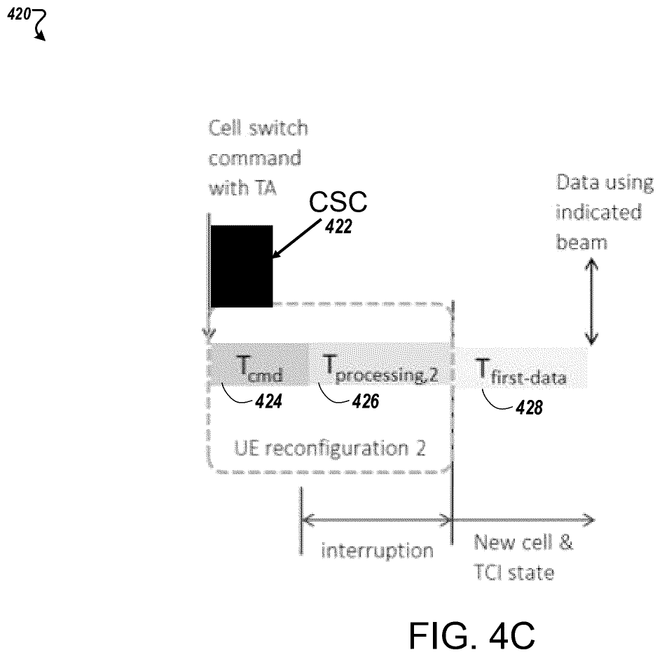

FIGS. 4A-4C each illustrates an example of a UE-based TA acquisition procedure for a UE. Specifically, each of FIGS. 4A-4C illustrates a process for enabling UE-based TA acquisition. For a UE-based TA measurement, the UE is configured to determine the TA based on a receive (Rx) timing difference between a current serving cell and a candidate cell and based on the TA value for the current serving cell. The UE updates the TA configuration based on the changes to the measured timing difference between a current serving cell and a candidate cell as the UE moves through the environment relative to the serving cell or candidate cell(s).

The UE updates the supported number of cells for which the UE is able to update TA configurations based on memory, bandwidth and power constraints of the UE. The UE is configured to report that the UE supports UE-based TA acquisition and also the configuration(s) of the UE-based TA measurement that are supported. A number of examples are possible for the UE and/or network to determine candidate cells for operation of the UE-based TA acquisition procedure and to enable or configure the UE-based TA acquisition for candidate cells in LTM operation.

FIG. 4A shows an example of RRC signaling process 400 for enabling or configuring the UE-based TA acquisition procedure. A UE-dedicated RRC signaling can be provided to enable the UE-based TA acquisition procedure for LTM operation for a given UE. For example, an RRC parameter called UE-based TA can be included in the LTM configuration data.

The RRC signal 402 specifies UE reconfiguration data. In some implementations, the RRC signaling provides enable/or disable (e.g., on-off indication) of the TA acquisition for a candidate cell on a per-UE basis. In this example, a given information element (IE) is configured on a per UE basis as follows. The IE specifies the fields {UE-based TA, ENUMERATED {enabled/disabled}}. In some implementations, when the second field of the IE UE-based TA is set to be ‘enabled’, the UE-based TA acquisition procedure is enabled for all of candidate cells to maintain uplink timing advance (UL TA). In another example, an on/off indicator for the UE-based TA acquisition procedure is provided per candidate cell. This has greater granularity than a per-UE signal because some candidate cells may be suitable while others are not suitable for communication with the UE in LTM for UE-based TA. Suitability can be based on the ability for time synchronization among the candidate cells and serving cell. For example, suitability of the candidate cell(s) can be based on inter-DL or intra-DL capability. For each candidate cell in LTM, the field UE-based TA is included to indicate whether the UE-based TA acquisition procedure is enabled for the particular identified candidate cell.

In the process 400 of FIG. 4A, the UE receives the RRC signal 402 at a time period TRRC. The UE then processes the RRC signal at T_{processing,1}. The UE then configures in accordance with the RRC signaling by enabling or disabling TA acquisition for specified candidate cell(s). The UE, at step 404, performs a downlink synchronization process based on the configuration specified in the RRC signaling at step 402. The UE searches in a search space at T_{search}, and also performs measurements of signals from candidate cell(s) during Tₘₑₐₛ. The measurement report 406 can then be sent based on the measured signals.

This specification describes how to trigger the UE to perform the TA update for candidate cell for the UE-based TA acquisition. This specification describes how to efficiently manage the candidate cells to enable UE-based TA acquisition when the UE may only support a limited number of cells for such a procedure. The UE-based TA acquisition processes described herein can enable removal of uplink synchronization procedures in legacy handover steps for LTM.

FIG. 4B illustrates an example of a UE-based TA acquisition procedure 410 for a UE based on a MAC CE. In some implementations, the MAC CE 412 is used after the RRC signaling 402 of FIG. 4A is performed in an initial state. The network (e.g., though a base station) can send the MAC CE to the UE to specify which cells are candidate cells that are eligible for UE-based TA acquisition. In some implementations, the network transmits, to the UE, the RRC signaling of FIG. 4A in a first instance or initial configuration stage, and transmits the MAC CE for subsequent changes to enable/disable candidate cells for UE-based TA acquisition. For example, the network may have already selected a target cell. The network transmits, by the MAC CE 412, a transmission configuration indicator (TCI)-state activation command. TCI states are dynamically sent over in a DCI message which includes configurations such as quasi co-location (QCL)-relationships between the downlink (DL) reference signals (RSs) in one CSI-RS set and the physical downlink shared channel (PDSCH) demodulation reference signal (DMRS) ports. The UE receives the MAC CE 412 during DL synchronization 414 (e.g., similar to DL synchronization 404 of FIG. 4A). Because the target cells may have already been selected, transmission of the activation signal can initiate the DL synchronization for the UE. There are a significantly reduced number of candidate cells that have been identified.

The MAC CE 412 changes the DL synchronization process for the UE, as shown in FIG. 4B. The UE receives the MAC CE specifying that the UE-based TA acquisition procedure is enabled through the TCI-state activation data. The UE receives the MAC CE 414 before a cell-switching operation for a given candidate cell. In some implementations, the UE receives an indicator, such as a 1-bit UE-based TA indicator 416. When the indicator 416 is set to be ‘enabled’ (e.g., ‘1’) in the MAC-CE 412, the UE starts deriving the TA value for candidate cell based on the TA value of serving cell and the DL Reception Timing Difference (RTD) between the serving cell and a target cell. The UE determines a timing difference TA 418. The UE determines a timing margin T_{margin} 420.

As part of the MAC CE 412, the UE adds the corresponding candidate cells identified in the MAC CE 412 to maintain UE TA acquisition or not. On the UE side, the power consumption is reduced as only a relatively small number of candidate cells (e.g., one or two cells) are identified as target cells. The UE maintains TA acquisition for only these identified cells. This second step can be based on RSRP reporting (e.g., measured in the T measurement report 406 of FIG. 4A). The MAC CE 412 can therefore specify a small number of target cells for DL synchronization, reducing power consumption overhead for the UE significantly. For example, assuming eight candidate cells are configured for measurement and only two of these candidate cells are addressed by MAC-CE to activate the TCI-states, the power consumption for UE TA measurement is reduced to 2/8=25%.

FIG. 4C illustrates an example of a UE-based TA acquisition procedure 420 for a UE based on a cell-switch command (CSC). Generally, the UE performs the procedure 420 once only one candidate cell is remaining as a target cell. For example, the UE can perform process 420 after each of processes 400, 410 have been performed. In some implementations, the process 420 can be performed independent of either of processes 400, 410, or both.

Once the cell-switching command (CSC) is triggered, there is one candidate cell for the UE-based TA acquisition to maintain a TA value. As shown in FIG. 4C, the CSC 422 is received by the UE at a time T_{cmd} 424. The UE processes the command at T_{processsing,2} 426. The UE reconfiguration occurs as the UE switches to the new cell identified in the CSC. The UE then transmits data at time T_{first-data} 428 using the updated TCI state, and data are transmitted by the UE using the indicated beam.

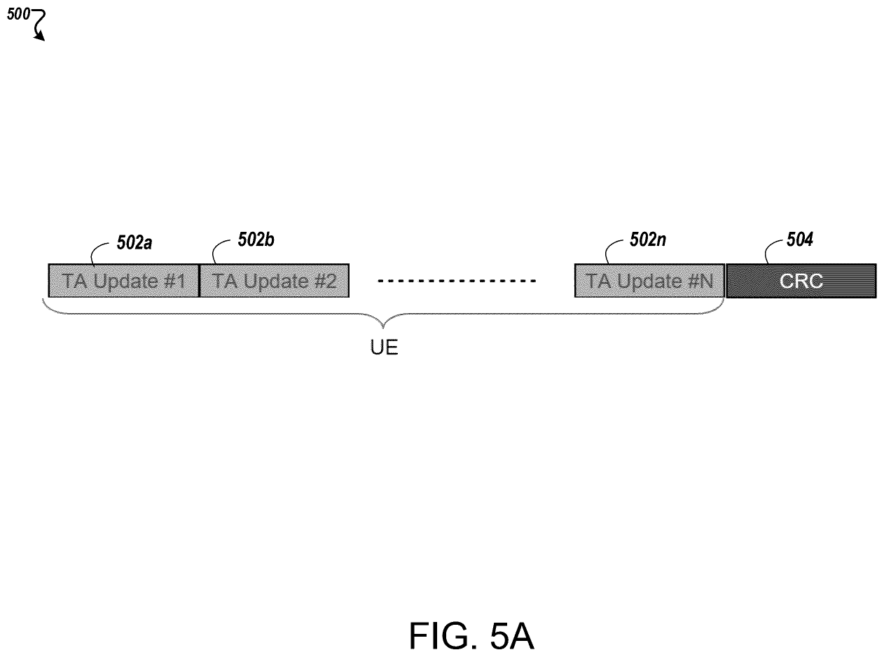

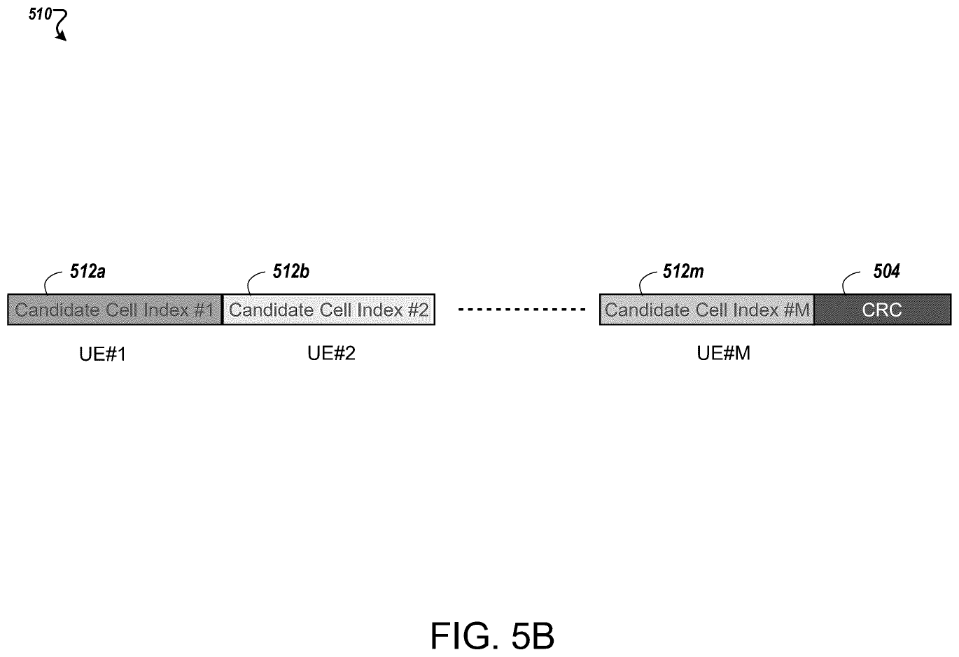

FIGS. 5A-5B illustrate example signaling 500 including DCI formats configured to trigger the TA update procedure. Generally, the network triggers the UE to perform the TA update for candidate cell for the UE-based TA acquisition. A variety of approaches maybe considered to determine the time instance to update TA associated with candidate cells for the UE-based TA acquisition procedure in LTM. For example, for each candidate cell in LTM, dedicated RRC signaling from the network for a UE configures a TA update timer. When the TA update timer expires, the UE performs the timing difference measurement and update the TA value for candidate cell accordingly.

The network may operate to trigger the UE to perform the TA update for candidate cell for the UE-based TA acquisition based on predefined scenarios. For example, a set of timing accuracy requirements can be known in advance to the UE for the UE to trigger a TA update. The UE maintains the TA for the candidate cell and meets the TA requirement that is predefined, such that the network does not need to signal to the UE any particular requirements for maintaining or updating the TA. The UE comports with the predefined requirements. For instance, a timing error (TE) requirement maybe defined in 3GPP specification such that the UE transmission timing error derived based on the UE-based TA acquisition should be smaller than ±Tₑ where the limit value Tₑ is specified in specification for each SCS of SSB signals.

The network may operate to trigger the UE to perform the TA update for candidate cell for the UE-based TA acquisition based on a specified DCI format. The DCI format triggers the TA updating as follows. In a given DCI format 500, shown in FIG. 5A, a set of TA update fields 502a-n are included. These fields include TA update #1, TA update #2, . . . , TA update #N, and so forth. In some implementations, the UE is configured by RRC signaling to associate a candidate cell with a respective TA update fields 502a-n of DCI format 500. In some implementations, the association between a candidate cell and TA update field is implicitly determined based on the candidate cell index, and no additional specification is needed in RRC signaling. For example, the candidate cell indexes can be arranged in increasing order, where ‘TA update #1’is associated with candidate cell with the smallest index value. Other such implicit associations can be used. In some implementations, a size of new DCI format 500 is configurable by RRC signaling. In this example, the UE can update TA values for multiple cells for that same UE.

FIG. 5B illustrates an example of a DCI format 510 configured to trigger the TA update procedure. In this example, there are generally a limited number of candidate cells. The DCI format 510 is a group-common DCI format that includes of the following fields 512a-m: Candidate cell index #1, Candidate cell index #2 . . . , Candidate cell index #M. In DCI format 510, a first candidate cell index field 5102a is configured for a first UE (e.g., UE 102, 202, 302, etc.) and different candidate cell index field (e.g., fields 512b . . . 512m) are used for respective different UEs. Therefore, many UEs use the same DCI, and each UE can be associated with a particular candidate cell for updating TA values. In some implementations, a size of new DCI format 510 is configurable by RRC signaling. For DCI formats 500 and 510, the network controls TA updating.

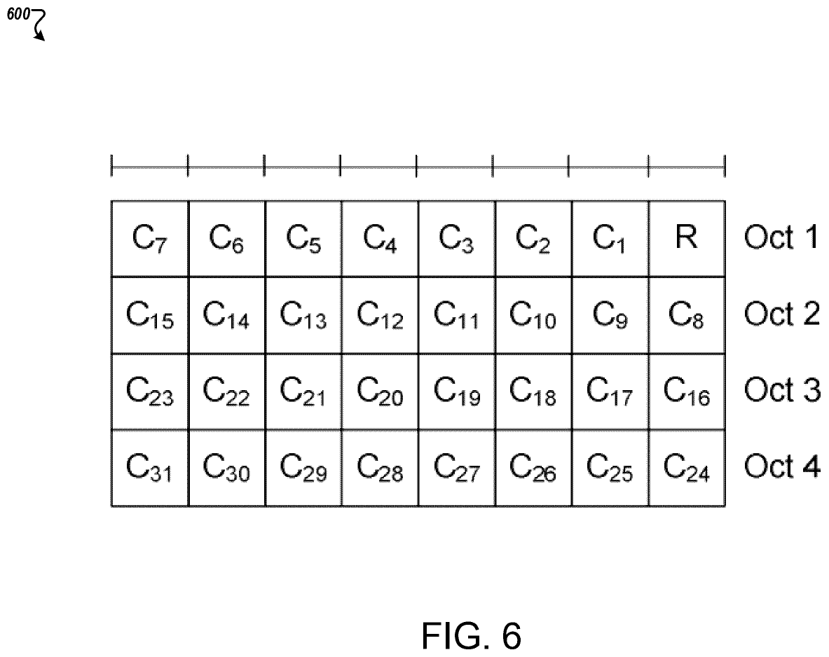

FIG. 6 illustrates an example of a MAC CE 600 configured for activating or deactivating a subset of candidate cells for a UE-based TA acquisition procedure. The MAC-CE 600 is configured to dynamically activate or deactivate a subset of candidate cells to perform the UE-based TA acquisition procedure. The number of indexes C₁ . . . Cₙ of the MAC CE 600 can be based on the number of candidate cells that are available. The UE-based TA acquisition procedure can be based on L1-RSRP reporting from the UE.

The new activation/deactivation MAC-CE consists of the following fields. A first field is Cᵢ, which indicates a candidate cell configured with candidate cell index ‘i’. The Cᵢ field(s) each indicates the activation/deactivation status of UE-based TA acquisition procedure for the candidate cell with candidate cell index i. If no cell is associated with the Cᵢ field, the MAC entity ignores the Cᵢ field. When the Cᵢ field is set to ‘1’, the UE-based TA acquisition procedure for the candidate cell configured with candidate cell index ‘i’ is activated if it is in deactivated state, otherwise the Cᵢ field set to ‘1’ is ignored. The Cᵢ field is set to ‘0’ to indicate that UE-based TA acquisition procedure for the candidate cell configured with candidate cell index ‘i’ is to be deactivated. The MAC-CE 600 has a fixed size, consisting of ‘N’ octets. The MAC CE 600 is separate from other MAC CEs designated for the cells designated by the logical cell identifier (eLCID). The MAC CE 600 is used based on the RSRP report(s) for a UE. The base station can determine, based on the RSRP report of the UE, which candidate cells are triggered for handover, and update the UE using the MAC CE 600. In the example MAC CE 600, four octets are shown, but other numbers for the octets are possible. In some implementations, the MAC-CE 600 is identified by a MAC PDU subheader with dedicated eLCID.

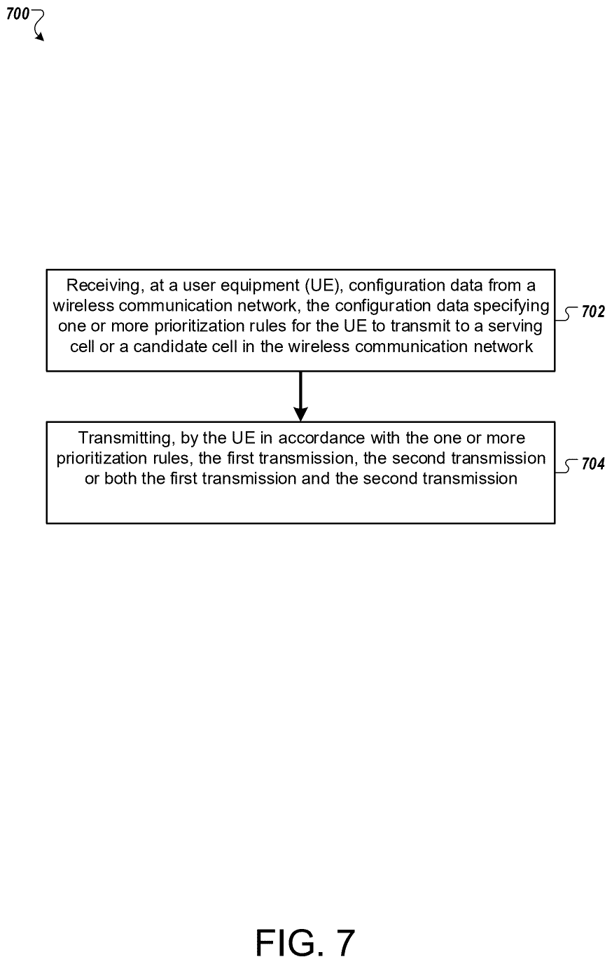

FIGS. 7, 8, and 9 each illustrates a flowchart of an example respective method 700, 800, and 900, according to some implementations. For clarity of presentation, the description that follows generally describes methods 700, 800, and 900 in the context of the other figures in this description. For example, methods 700, 800, and 900 can be performed by UE 102 of FIG. 1. It will be understood that methods 700, 800, and 900 can be performed, for example, by any suitable system, environment, software, hardware, or a combination of systems, environments, software, and hardware, as appropriate. In some implementations, various steps of method methods 700, 800, and 900 can be run in parallel, in combination, in loops, or in any order.

FIG. 7 shows an example process 700. Process 700 includes receiving (702), at a user equipment (UE), configuration data from a wireless communication network, the configuration data specifying one or more prioritization rules for the UE to transmit to a serving cell or a candidate cell in the wireless communication network, the one or more prioritization rules specifying transmission priority for a first transmission on a serving cell comprising a physical data or control channel and a second transmission on a candidate non-serving cell comprising a physical random access channel (PRACH) when the UE is scheduled to perform the first transmission and the second transmission and the first transmission and the second transmission overlap in time. Process 700 includes transmitting (704), by the UE in accordance with the one or more prioritization rules, the first transmission, the second transmission or both the first transmission and the second transmission.

In some implementations, the configuration data are transmitted from the communication network as part of a system information block (SIB). In some implementations, the configuration data are transmitted from the communication network as part of radio resource control (RRC) signaling. In some implementations, the one or more priority rules for the UE are for a lower layer triggered mobility (LTM) scenario for the UE.

In some implementations, the physical data or control channel comprises a physical uplink shared channel (PUSCH). In some implementations, the physical data or control channel comprises a physical uplink control channel (PUCCH). In some implementations, the one or more prioritization rules specify that, for a single frequency, the PRACH transmission to the candidate non-serving cell is prioritized over the overlapping PUSCH transmission to the serving cell on a same frequency.

In some implementations, the one or more prioritization rules specify that a PRACH transmission on a primary cell has a first priority, a contention-based random access (CFRA) PRACH transmission to one or more candidate non-serving cells has a second priority, a PUCCH or a PUSCH transmission on a serving cell has a third priority, an aperiodic sounding reference signal (SRS) on a serving cell has a fourth priority, a PRACH transmission on a secondary on a serving cell has a fifth priority, and a periodic or semi-persistent SRS on a serving cell has a sixth priority. In some implementations, the first transmission overlaps with the second transmission, and wherein the serving cell is in a first frequency, and wherein the candidate cell is within a second frequency. In some implementations, the one or more prioritization rules specify that the second transmission using the PRACH is prioritized over the first transmission using a PUSCH when they are overlapped in time domain.

In some implementations, the UE has at least two CFRA PRACH transmissions on two candidate non-serving cells overlap in time, and wherein the one or more prioritization rules specify a prioritization for the at least two overlapping CFRA PRACH transmissions based on a respective cell identifier of a respective candidate cell that is associated with each respective CRFA PRACH transmission of the at least two overlapping CRFA PRACH transmissions.

In some implementations, the first transmission overlaps with the second transmission in time and frequency, wherein the UE is not capable of simultaneous uplink transmissions over multiple panels (STxMP), and wherein the one or more prioritization rules specify that the second transmission comprising the PRACH transmission has a higher priority than the first transmission, the first transmission comprising a PUSCH transmission.

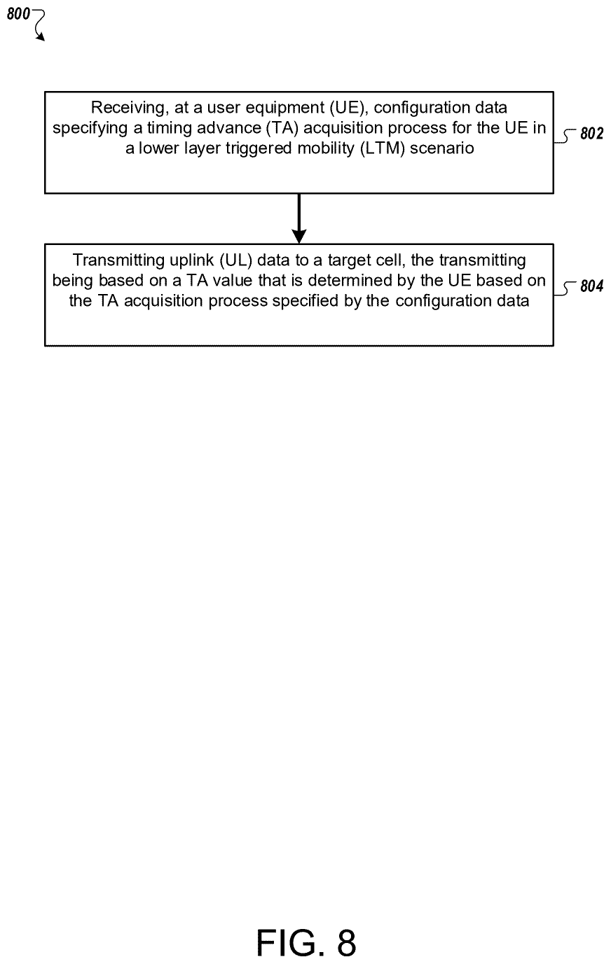

FIG. 8 shows an example process 800. Process 800 includes receiving (802), at a user equipment (UE), configuration data specifying a timing advance (TA) acquisition process for the UE in a L1 or L2 triggered mobility (LTM) operation. Process 800 includes transmitting (804) uplink (UL) data to a target cell, the transmitting being based on a TA value that is determined by the UE based on the TA acquisition process specified by the configuration data.

In some implementations, the configuration data is received at the UE based on dedicated radio resource control (RRC) signaling. In some implementations, the RRC signaling comprises an indicator that indicates an on state for the UE or an off state for the UE where the ‘on’ state is used to enable the TA acquisition process for all the candidate non-serving cells and the ‘off’ state is used to disable the TA acquisition process for all the candidate non-serving cells. In some implementations, the RRC signaling comprises an indicator for each candidate cell of the set of candidate cells that indicates an on state or an off state for the UE-based TA acquisition process, wherein the target cell of LTM operation is a candidate cell of the set of candidate cells.

In some implementations, the configuration data is received at the UE based on a medium access control (MAC) control element (CE), the MAC CE activating a set of transmission configuration indicator (TCI) states before a cell-switching operation for a candidate cell, wherein a separate field in the MAC CE enables the TA acquisition process for the candidate cell.

In some implementations, the UE is configured to derive a TA value for a candidate cell based on a TA value of a serving cell and a downlink reception timing difference (RTD) between the serving cell and the candidate cell responsive to the MAC-CE activating the TCI state(s) for the candidate cell.

In some implementations, a cell-switch command (CSC) triggering cell switch to a candidate non-serving cell enables the TA acquisition process for the candidate non-serving cell.

In some implementations, a medium access control (MAC) control element (CE) is configured to activate or deactivate the TA acquisition process based on a receive signal receive power (RSRP) associated with different candidate non-serving cells of the UE. In some implementations, the MAC CE comprises a plurality of index fields, each index field associated with a candidate cell index, and wherein a value of a given index field Cᵢ indicates an activation or deactivation of a candidate cell associated with the candidate index of the given index field Ci. In some implementations, the MAC CE has a fixed size.

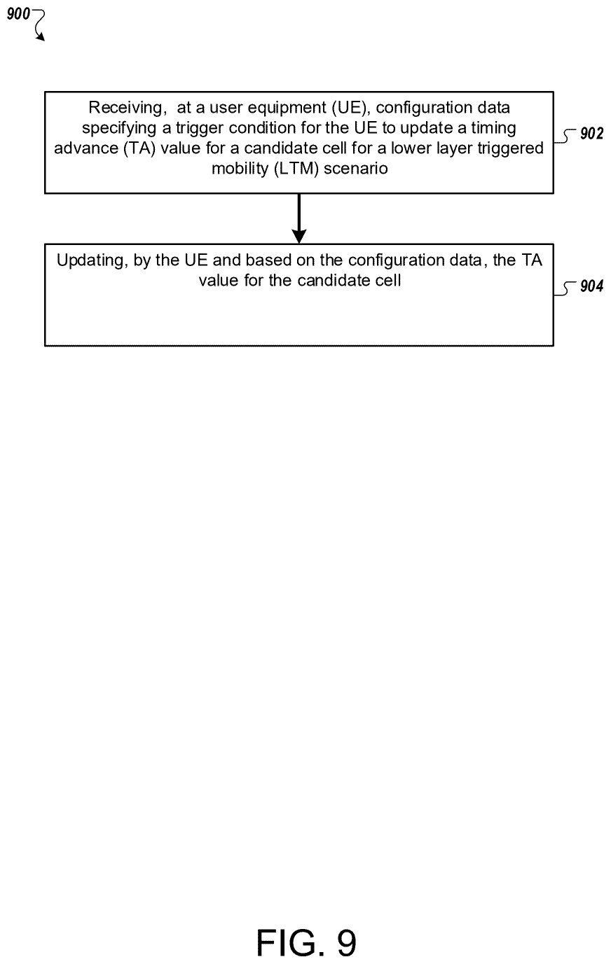

FIG. 9 shows an example process 900. Process 900 includes receiving (902), receiving, at a user equipment (UE), configuration data specifying a trigger condition for the UE to update a timing advance (TA) value for a candidate cell for a L1/L2 layer triggered mobility (LTM) operation. Process 900 includes updating (904) by the UE and based on the configuration data, the TA value for the candidate cell.

In some implementations, the configuration data is transmitted to the UE based on radio resource control (RRC) signaling, wherein the configuration data specifies a TA update timer, and wherein the UE is configured to update the TA value for the candidate cell when the TA update timer expires.

In some implementations, the set of timing accuracy requirements is predefined in a specification, and wherein the UE updates the TA value to meet the predefined timing accuracy requirement that is independent of receiving the configuration data.

In some implementations, the configuration data is transmitted to the UE based on downlink control information (DCI) format. In some implementations, the DCI format comprises a plurality of fields for a common UE, wherein each field of the plurality specifies a TA update value that indicate whether the common UE is triggered to update the TA value for a corresponding candidate cell. In some implementations, the field index of TA update value for a corresponding candidate non-serving cell is configured based on RRC signaling. In some implementations, the TA update value for each corresponding candidate cell is associated based on an order of the fields in the DCI format, wherein TA values of the plurality of fields are assigned to respective candidate cells based on the respective cell indexes of the candidate cells. In some implementations, the DCI format comprises a plurality of fields, wherein each field of the plurality specifies, for a respective different UE, a corresponding candidate cell index.

The example methods 700, 800, and 900 shown in FIGS. 7, 8, and 9 can be modified or reconfigured to include additional, fewer, or different steps (not shown in FIGS. 7, 8, or 9), which can be performed in the order shown or in a different order.

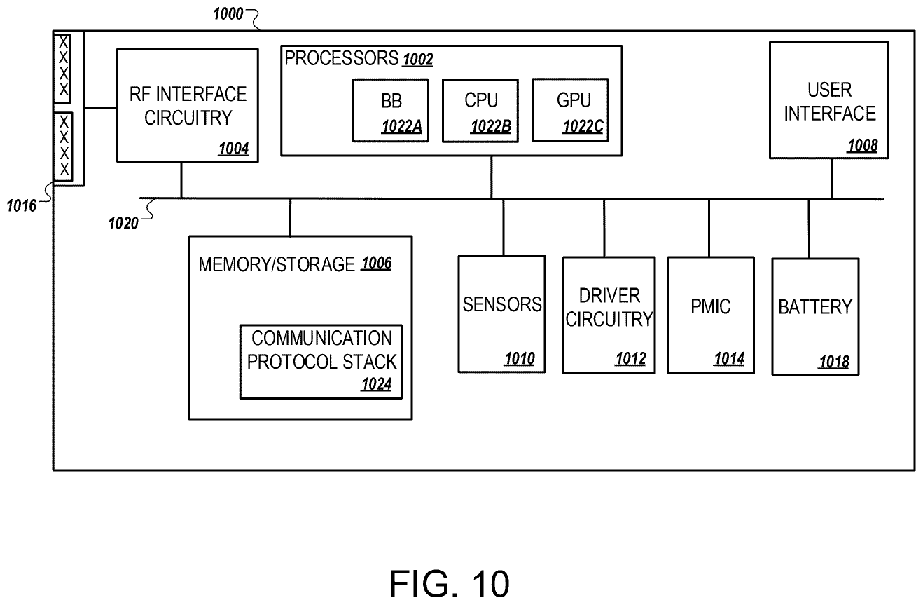

FIG. 10 illustrates an example UE 1000, according to some implementations. The UE 1000 may be similar to and substantially interchangeable with UE 102 of FIG. 1.

The UE 1000 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 1000 may include processors 1002, RF interface circuitry 1004, memory/storage 1006, user interface 1008, sensors 1010, driver circuitry 1012, power management integrated circuit (PMIC) 1014, one or more antenna(s) 1016, and battery 1018. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1020, which may represent any type of interface, input/output, bus (local, system, or expansion), transmission line, trace, optical connection, etc. that allows various circuit components (on common or different chips or chipsets) to interact with one another.

The processors 1002 may include processor circuitry such as, for example, baseband processor circuitry (BB) 1022A, central processor unit circuitry (CPU) 1022B, and graphics processor unit circuitry (GPU) 1022C. The processors 1002 may include any type of circuitry or processor circuitry that executes or otherwise operates computer-executable instructions, such as program code, software modules, or functional processes from memory/storage 1006 to cause the UE 1000 to perform operations as described herein.

In some implementations, the baseband processor circuitry 1022A may access a communication protocol stack 1024 in the memory/storage 1006 to communicate over a 3GPP compatible network. In general, the baseband processor circuitry 1022A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1004. The baseband processor circuitry 1022A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1006 may include one or more non-transitory, computer-readable media that includes instructions (for example, communication protocol stack 1024) that may be executed by one or more of the processors 1002 to cause the UE 1000 to perform various operations described herein. The memory/storage 1006 include any type of volatile or non-volatile memory that may be distributed throughout the UE 1000. In some implementations, some of the memory/storage 1006 may be located on the processors 1002 themselves (for example, L1 and L2 cache), while other memory/storage 1006 is external to the processors 1002 but accessible thereto via a memory interface. The memory/storage 1006 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1004 may include transceiver circuitry and radio frequency front module (RFEM) that allows the UE 1000 to communicate with other devices over a radio access network. The RF interface circuitry 1004 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 1016 and proceed to filter and amplify (with a low-noise amplifier) the signal. The signal may be provided to a receiver of the transceiver that downconverts the RF signal into a baseband signal that is provided to the baseband processor of the processors 1002.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 1016. In various implementations, the RF interface circuitry 1004 may be configured to transmit/receive signals in a manner compatible with NR access technologies.

The antenna(s) 1016 may include one or more antenna elements to convert electrical signals into radio waves to travel through the air and to convert received radio waves into electrical signals. The antenna elements may be arranged into one or more antenna panels. The antenna(s) 1016 may have antenna panels that are omnidirectional, directional, or a combination thereof to enable beamforming and multiple input, multiple output communications. The antenna(s) 1016 may include microstrip antennas, printed antennas fabricated on the surface of one or more printed circuit boards, patch antennas, phased array antennas, etc. The antenna(s) 1016 may have one or more panels designed for specific frequency bands including bands in FR1 or FR2.

The user interface 1008 includes various input/output (I/O) devices designed to enable user interaction with the UE 1000. The user interface 1008 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1000.

The sensors 1010 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or r nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1012 may include software and hardware elements that operate to control particular devices that are embedded in the UE 1000, attached to the UE 1000, or otherwise communicatively coupled with the UE 1000. The driver circuitry 1012 may include individual drivers allowing other components to interact with or control various input/output (I/O) devices that may be present within, or connected to, the UE 1000. For example, driver circuitry 1012 may include a display driver to control and allow access to a display device, a touchscreen driver to control and allow access to a touchscreen interface, sensor drivers to obtain sensor readings of sensors 1010 and control and allow access to sensors 1010, drivers to obtain actuator positions of electro-mechanic components or control and allow access to the electro-mechanic components, a camera driver to control and allow access to an embedded image capture device, audio drivers to control and allow access to one or more audio devices.

The PMIC 1014 may manage power provided to various components of the UE 1000. In particular, with respect to the processors 1002, the PMIC 1014 may control power-source selection, voltage scaling, battery charging, or DC-to-DC conversion.

In some implementations, the PMIC 1014 may control, or otherwise be part of, various power saving mechanisms of the UE 1000. A battery 1018 may power the UE 1000, although in some examples the UE 1000 may be mounted deployed in a fixed location, and may have a power supply coupled to an electrical grid. The battery 1018 may be a lithium ion battery, a metal-air battery, such as a zinc-air battery, an aluminum-air battery, a lithium-air battery, and the like. In some implementations, such as in vehicle-based applications, the battery 1018 may be a typical lead-acid automotive battery.

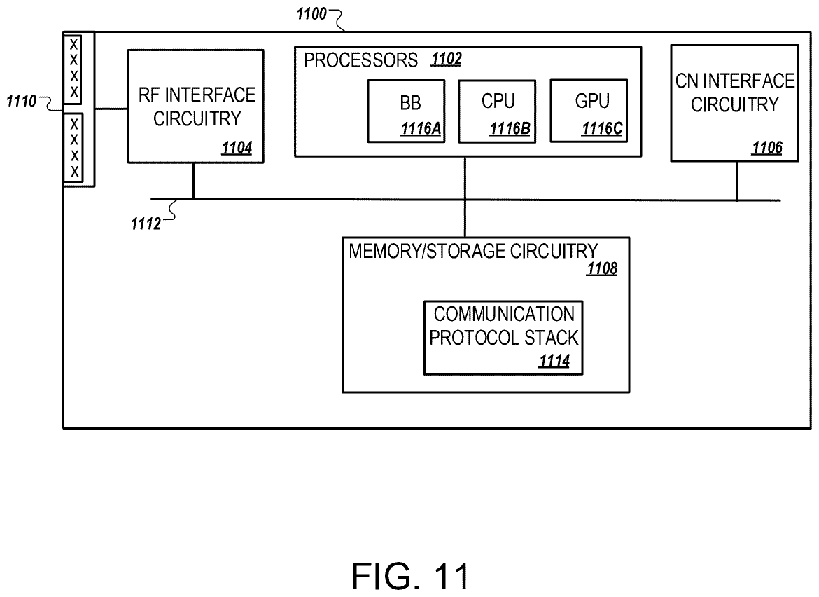

FIG. 11 illustrates an example access node 1100 (e.g., a base station or gNB), according to some implementations. The access node 1100 may be similar to and substantially interchangeable with base station 104. The access node 1100 may include processors 1102, RF interface circuitry 1104, core network (CN) interface circuitry 1106, memory/storage circuitry 1108, and one or more antenna(s) 1110.

The components of the access node 1100 may be coupled with various other components over one or more interconnects 1112. The processors 1102, RF interface circuitry 1104, memory/storage circuitry 1108 (including communication protocol stack 1114), antenna(s) 1110, and interconnects 1112 may be similar to like-named elements shown and described with respect to FIG. 10. For example, the processors 1102 may include processor circuitry such as, for example, baseband processor circuitry (BB) 1116A, central processor unit circuitry (CPU) 1116B, and graphics processor unit circuitry (GPU) 1116C.

The CN interface circuitry 1106 may provide connectivity to a core network, for example, a 5th Generation Core network (5GC) using a 5GC-compatible network interface protocol such as carrier Ethernet protocols, or some other suitable protocol. Network connectivity may be provided to/from the access node 1100 via a fiber optic or wireless backhaul. The CN interface circuitry 1106 may include one or more dedicated processors or FPGAs to communicate using one or more of the aforementioned protocols. In some implementations, the CN interface circuitry 1106 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1100 that operates in an NR or 5G system (for example, a gNB), and the term “E-UTRAN node” or the like may refer to an access node 1100 that operates in an LTE or 4G system (e.g., an eNB). According to various implementations, the access node 1100 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1100 may be implemented as one or more software entities running on server computers as part of a virtual network, which may be referred to as a CRAN and/or a virtual baseband unit pool (vBBUP). In V2X scenarios, the access node 1100 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A method comprising:
receiving, at a user equipment (UE), a configuration data from a wireless communication network, the configuration data specifying one or more prioritization rules for the UE to transmit to a serving cell or a candidate cell in the wireless communication network, the one or more prioritization rules specifying transmission priority for a first transmission on a serving cell comprising a physical data or control channel and a second transmission on a candidate non-serving cell comprising a physical random access channel (PRACH) when the UE is scheduled to perform the first transmission and the second transmission and the first transmission and the second transmission overlap in time; and
transmitting, by the UE in accordance with the one or more prioritization rules, the first transmission, the second transmission or both the first transmission and the second transmission.

2. The method of claim 1, wherein the configuration data are transmitted from the communication network as part of a system information block (SIB).

3. The method of claim 1, wherein the configuration data are transmitted from the communication network as part of radio resource control (RRC) signaling.

4. The method of claim 1, wherein the one or more prioritization rules for the UE are applied when a layer 1/layer 2 (L1/L2)-triggered mobility (LTM) operation is enabled for the UE

5. The method of claim 1, wherein the physical data or control channel comprises a physical uplink shared channel (PUSCH).

6. The method of claim 1, wherein the physical data or control channel comprises a physical uplink control channel (PUCCH).

7. The method of claim 1, wherein the one or more prioritization rules specify that, for a single frequency, a PRACH transmission to the candidate non-serving cell is prioritized over an overlapping PUSCH transmission to the serving cell on a same frequency.

8. The method of claim 1, wherein the one or more prioritization rules specify that a PRACH transmission on a primary cell has a first priority, a contention-based random access (CFRA) PRACH transmission to one or more candidate non-serving cells has a second priority, a PUCCH or a PUSCH transmission on a serving cell has a third priority, an aperiodic sounding reference signal (SRS) on a serving cell has a fourth priority, a PRACH transmission on a secondary on a serving cell has a fifth priority, and a periodic or semi-persistent SRS on a serving cell has a sixth priority.

9. The method of claim 1, wherein the first transmission overlaps with the second transmission, and wherein the serving cell is in a first frequency, and wherein the candidate cell is within a second frequency.

10. The method of claim 9, wherein the one or more prioritization rules specify that the second transmission using the PRACH is prioritized over the first transmission using a PUSCH when they are overlapped in time domain.

11. The method of claim 1, wherein the UE has at least two CFRA PRACH transmissions on two candidate non-serving cells overlap in time, and wherein the one or more prioritization rules specify a prioritization for the at least two overlapping CFRA PRACH transmissions based on a respective cell identifier of a respective candidate cell that is associated with each respective CRFA PRACH transmission of the at least two overlapping CRFA PRACH transmissions.

12. The method of claim 1, wherein the first transmission overlaps with the second transmission in time and frequency, wherein the UE is not capable of simultaneous uplink transmissions over multiple panels (STxMP), and wherein the one or more prioritization rules specify that the second transmission comprising a PRACH transmission has a higher priority than the first transmission, the first transmission comprising a PUSCH transmission.

13. A method, comprising:
receiving, at a user equipment (UE), a configuration data specifying a timing advance (TA) acquisition process for the UE in a L1/L2-triggered mobility (LTM) scenario; and
transmitting uplink (UL) data to a target cell, the transmitting being based on a TA value that is determined by the UE based on the TA acquisition process specified by the configuration data.

14. The method of claim 13, wherein the configuration data is received at the UE based on dedicated radio resource control (RRC) signaling.

15. The method of claim 14, wherein the RRC signaling comprises an indicator that indicates an on state for the UE or an off state for the UE where the on state is used to enable the TA acquisition process for all candidate non-serving cells and the off state is used to disable the TA acquisition process for all the candidate non-serving cells.

16. The method of claim 14, wherein the RRC signaling comprises an indicator for each candidate cell of a set of candidate cells that indicates an on state or an off state for the TA acquisition process, wherein a target cell of LTM operation is a candidate cell of the set of candidate cells.

17. The method of claim 13, wherein the configuration data is received at the UE based on a medium access control (MAC) control element (CE), the MAC CE activating a set of transmission configuration indicator (TCI) states before a cell-switching operation for a candidate cell, wherein a separate field in the MAC CE enables the TA acquisition process for the candidate cell.

18. The method of claim 17, wherein the UE is configured to derive a TA value for a candidate cell based on a TA value of a serving cell and a downlink reception timing difference (RTD) between the serving cell and the candidate cell responsive to the MAC CE activating the TCI state(s) for the candidate cell.

19. The method of claim 13, wherein a cell-switch command (CSC) triggering cell switch to a candidate non-serving cell enables the TA acquisition process for the candidate non-serving cell.

20. A method, comprising:
receiving, at a user equipment (UE), configuration data specifying a trigger condition for the UE to update a timing advance (TA) value for a candidate cell for a L1/L2 triggered mobility (LTM) operation; and
updating, by the UE and based on the configuration data, the TA value for the candidate cell.

21. The method of claim 20, wherein the configuration data is transmitted to the UE based on radio resource control (RRC) signaling, wherein the configuration data specifies a TA update timer, and wherein the UE is configured to update the TA value for the candidate cell when the TA update timer expires.

22. The method of claim 20, wherein a set of timing accuracy requirements is predefined in a specification, and wherein the UE updates the TA value to meet the predefined timing accuracy requirement that is independent of receiving the configuration data.

23. The method of claim 20, wherein the configuration data is transmitted to the UE based on downlink control information (DCI) format.

24. The method of claim 23, wherein the DCI format comprises a plurality of fields for a common UE, wherein each field of the plurality specifies a TA update value that indicate whether the common UE is triggered to update the TA value for a corresponding candidate cell.

25. The method of claim 24, wherein a field index of the TA update value for a corresponding candidate non-serving cell is configured based on RRC signaling.

26. The method of claim 24, wherein the TA update value for each corresponding candidate cell is associated based on an order of the fields in the DCI format, wherein TA values of the plurality of fields are assigned to respective candidate cells based on the respective cell indexes of the candidate cells.

27. The method of claim 23, wherein the DCI format comprises a plurality of fields, wherein each field of the plurality specifies, for a respective different UE, a corresponding candidate cell index.

28. The method of claim 12, wherein a medium access control (MAC) control element (CE) is configured to activate or deactivate a TA acquisition process based on a receive signal receive power (RSRP) associated with different candidate non-serving cells of the UE.

29. The method of claim 28, wherein the MAC CE comprises a plurality of index fields, each index field associated with a candidate cell index, and wherein a value of a given index field Cᵢ indicates an activation or deactivation of a candidate cell associated with the candidate index of the given index field Cᵢ.

30. The method of claim 28, wherein the MAC CE has a fixed size.

31. A system comprising one or more computers and one or more storage devices on which are stored instructions that are operable, when executed by the one or more computers, to cause the one or more computers to perform operations of any of the methods of claims 1-30.

32. A non-transitory computer storage medium encoded with instructions that, when executed by one or more computers, cause the one or more computers to perform operations of any of the methods of claims 1-30.

33. A processor of a user equipment (UE) configured to perform operations comprising:
receiving, at a user equipment (UE), a configuration data from a wireless communication network, the configuration data specifying one or more prioritization rules for the UE to transmit to a serving cell or a candidate cell in the wireless communication network, the one or more prioritization rules specifying transmission priority for a first transmission on a serving cell comprising a physical data or control channel and a second transmission on a candidate non-serving cell comprising a physical random access channel (PRACH) when the UE is scheduled to perform the first transmission and the second transmission and the first transmission and the second transmission overlap in time; and
transmitting, by the UE in accordance with the one or more prioritization rules, the first transmission, the second transmission or both the first transmission and the second transmission.

34. A processor of a user equipment (UE) configured to perform operations comprising:
receiving, at a user equipment (UE), a configuration data specifying a timing advance (TA) acquisition process for the UE in a L1/L2-triggered mobility (LTM) scenario; and
transmitting uplink (UL) data to a target cell, the transmitting being based on a TA value that is determined by the UE based on the TA acquisition process specified by the configuration data.

35. A processor of a user equipment (UE) configured to perform operations comprising:
receiving, at a user equipment (UE), configuration data specifying a trigger condition for the UE to update a timing advance (TA) value for a candidate cell for a L1/L2 triggered mobility (LTM) operation; and
updating, by the UE and based on the configuration data, the TA value for the candidate cell.
